(19) United States
(12) Patent Application Publication
(10) Pub. No.: US 2026/0018336 A1
(43) Pub. Date: Jan. 15, 2026

(54) MULTILAYER CERAMIC ELECTRONIC COMPONENT

(71) Applicant: Murata Manufacturing Co., Ltd., Nagaokakyo-shi (JP)

(72) Inventors: Tadateru YAMADA, Nagaokakyo-shi (JP); Yosuke TERASHITA, Nagaokakyo-shi (JP)

(21) Appl. No.: 19/338,088

(22) Filed: Sep. 24, 2025

Related U.S. Application Data
(63) Continuation of application No. PCT/JP2024/011939, filed on Mar. 26, 2024.

(30) Foreign Application Priority Data
Apr. 14, 2023 (JP) 2023-066335

(51) Int. Cl. H01G 2/06; H01G 4/30

(52) U.S. Cl. CPC H01G 2/065; H01G 4/30

(57) ABSTRACT

A multilayer ceramic electronic component includes a multilayer ceramic capacitor, and two spacers on one main surface side of the multilayer ceramic capacitor. Each of the spacers includes two spacer main surfaces facing each other in a first direction, two spacer side surfaces facing each other in a second direction, and two spacer end surfaces facing each other in a third direction. When the spacer is divided into n portions in the second direction in a plan view seen from the one spacer main surface side, each of the n regions obtained by the division includes a single protrusion protruding in the third direction.

### CROSS REFERENCE TO RELATED APPLICATIONS

This application claims the benefit of priority to Japanese Patent Application No. 2023-066335 filed on Apr. 14, 2023 and is a Continuation application of PCT Application No. PCT/JP2024/011939 filed on Mar. 26, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

In multilayer ceramic capacitors, an “acoustic noise” characteristic of the multilayer ceramic capacitors occurs when a voltage is applied. In order to reduce or prevent the occurrence of “acoustic noise”, a multilayer ceramic electronic component has been known in which a spacer is provided on one of the surfaces to be mounted on a board of a multilayer ceramic capacitor Japanese Unexamined Patent Application, Publication No. 2015-216337.

However, there are cases where the solder spreads up to the external electrode of the multilayer ceramic capacitor beyond the spacer, and even if a spacer is provided in a multilayer ceramic electronic component, the advantageous effects of reducing noise may not be sufficiently obtained.

### SUMMARY OF THE INVENTION

Example embodiments of the present invention provide multilayer ceramic electronic components each able to reduce or prevent spreading of solder to an end surface of an external electrode of a multilayer ceramic capacitor.

An example embodiment of the present invention provides a multilayer ceramic electronic component which includes a multilayer ceramic capacitor including a multilayer body including two multilayer body main surfaces opposed to each other in a first direction, two multilayer body lateral surfaces opposed to each other in a second direction intersecting the first direction, and two multilayer body end surfaces opposed to each other in a third direction intersecting the first direction and the second direction, and external electrodes each extending from a corresponding one of the two multilayer body end surfaces to a corresponding one of the two multilayer body main surfaces, and two spacers on one of the two multilayer body main surfaces of the multilayer ceramic capacitor, one of the two spacers being adjacent to one of the two multilayer body end surfaces, an other of the two spacers being adjacent to an other of the two multilayer body end surfaces, in which each of the two spacers includes two spacer main surfaces opposed to each other in the first direction, two spacer lateral surfaces opposed to each other in the second direction, and two spacer end surfaces opposed to each other in the third direction, and when one of the two spacers is divided into n number of divided regions in the second direction in a plan view viewed from one of the two spacer main surfaces, each of the n number of divided regions includes a protruding portion protruding in the third direction.

According to example embodiments of the present invention, multilayer ceramic electronic components each able to reduce or prevent spreading of solder to an end surface of an external electrode of a multilayer ceramic capacitor are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic electronic component according to an example embodiment of the present invention.

FIG. 2 is a cross-sectional view of a multilayer ceramic electronic component according to an example embodiment taken along the line II-II in FIG. 1.

FIG. 3 is a cross-sectional view of a multilayer ceramic electronic component according to an example embodiment taken along the line III-III in FIG. 1.

FIG. 4 is a plan view of a portion of the multilayer ceramic electronic component 1 to which the second spacer 4B is attached as viewed from a second spacer main surface a2.

FIG. 5 is a flowchart showing a method of manufacturing the multilayer ceramic electronic component 1.

FIGS. 6A to 6E are views showing a modified example of the spacer 4.

FIG. 7 is a view showing a modified example of the spacer 4.

FIG. 8 is a view showing a modified example of the spacer 4.

FIG. 9 is a view showing a modified example of the spacer 4.

FIG. 10 is a table showing measurement results of sound pressure levels of a multilayer ceramic electronic component 1 according to an example embodiment of the present invention in the spacer 4, in which protruding portions 5L are provided on a spacer end surface c and in which the number n of the protruding portions 5L is 2 to 8, and a multilayer ceramic electronic component according to a Comparative Example in which the number n of the protruding portions 5L is 0.

FIG. 11 is a table showing the results of measuring the sound pressure levels of a multilayer ceramic electronic component 1 according to an example embodiment of the present invention in which, in the spacer 4 in which the protruding portions 5W are provided on the spacer lateral surface b and in which the number m of the protruding portions 5W is 1 to 4, and a multilayer ceramic electronic component according to the Comparative Example in which the number m of the protruding portions 5W is 0.

### DETAILED DESCRIPTION OF THE EXAMPLE EMBODIMENTS

Example embodiments of the present invention will be described in detail below with reference to the drawings.

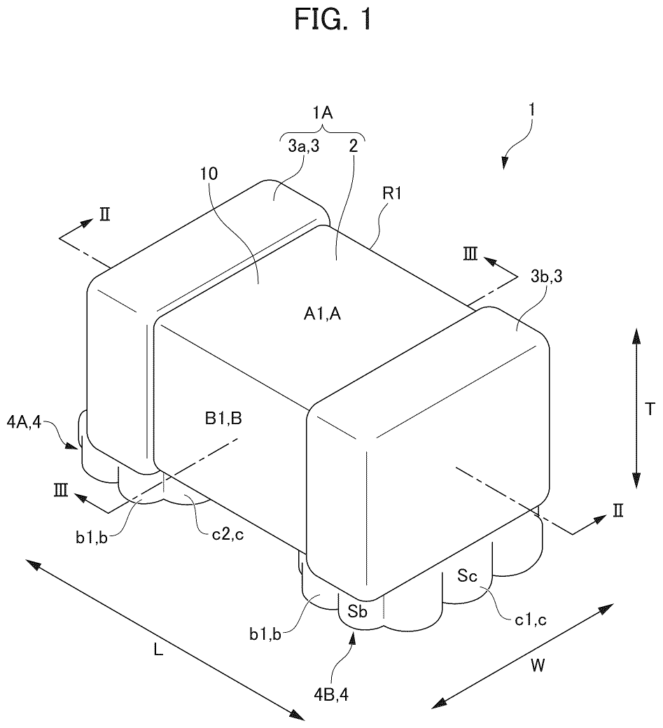

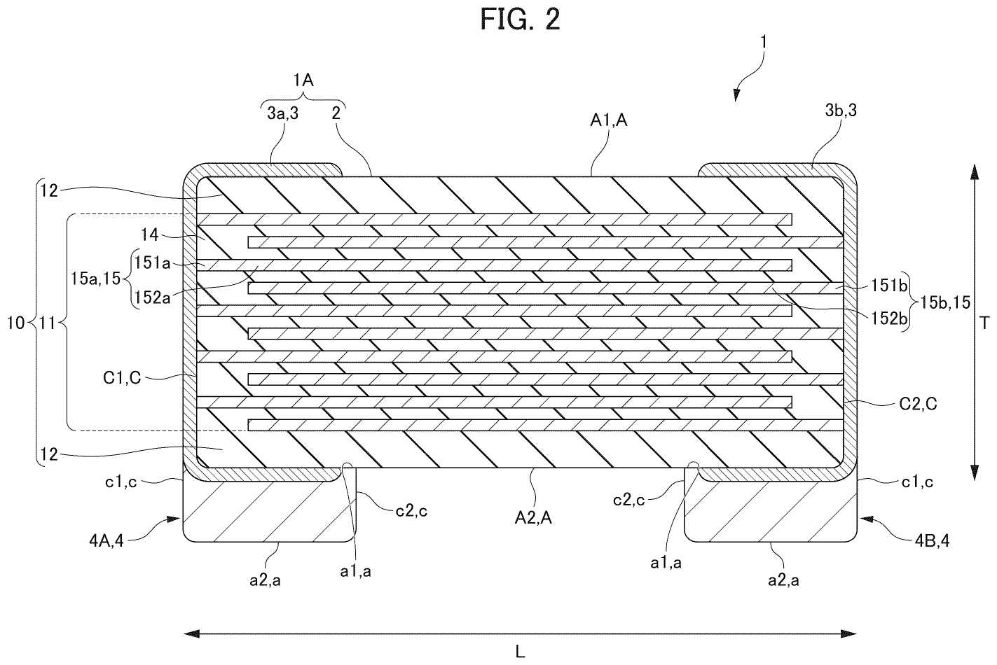

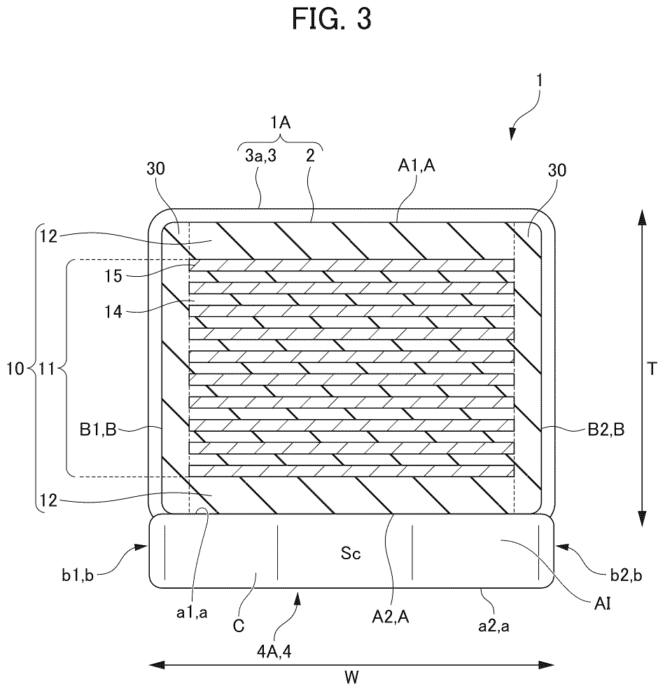

First, a multilayer ceramic electronic component 1 according to an example embodiment of the present invention will be described. FIG. 1 is a schematic perspective view of a multilayer ceramic electronic component 1 according to an example embodiment. FIG. 2 is a cross-sectional view of the multilayer ceramic electronic component 1 according to the example embodiment taken along the line II-II in FIG. 1. FIG. 3 is a cross-sectional view of the multilayer ceramic electronic component 1 according to an example embodiment taken along the line III-III in FIG. 1.

The multilayer ceramic electronic component 1 includes a multilayer ceramic capacitor 1A having a rectangular or substantially rectangular parallelepiped shape and including a multilayer body 2 and a pair of external electrodes 3 provided at both ends of the multilayer body 2, and spacers 4 attached to the multilayer ceramic capacitor 1A. The multilayer body 2 includes an inner layer portion 11 including a plurality of sets of ceramic layers 14 and internal electrode layers 15.

In the following description, as terms representing the orientation of the multilayer ceramic electronic component 1, a direction in which the ceramic layers 14 and the internal electrode layers 15 are laminated in the multilayer ceramic electronic component 1 is referred to as a height direction T (first direction). A direction in which the pair of external electrodes 3 are provided is defined as a length direction L (third direction) A direction intersecting both the length direction L and the height direction T is defined as a width direction W (second direction).

In example embodiments of the present invention, the width direction W is orthogonal or substantially orthogonal to both the length direction L and the height direction T.

### Outer Surface of Multilayer Body 2

Among the six outer surfaces of the multilayer body 2, a pair of outer surfaces opposed to each other in the height direction T is defined as a first multilayer body main surface A1 and a second multilayer body main surface A2, a pair of outer surfaces opposed to each other in the width direction W is defined as a first multilayer body lateral surface B1 and a second multilayer body lateral surface B2, and a pair of outer surfaces opposed to each other in the length direction L is defined as a first multilayer body end surface C1 and a second multilayer body end surface C2.

When it is not necessary to particularly distinguish between these pairs of outer surfaces opposed to each other for explanation, the first multilayer body main surface A1 and the second multilayer body main surface A2 are collectively referred to as a multilayer body main surface A, the first multilayer body lateral surface B1 and the second multilayer body lateral surface B2 are collectively referred to as a multilayer body lateral surface B, and the first multilayer body end surface C1 and the second multilayer body end surface C2 are collectively referred to as a multilayer body end surface C.

### Multilayer Body 2

In the multilayer body 2, it is preferable that the ridge portion R1 including the corner portion is rounded. The ridge portion R1 is a portion where two surfaces of the multilayer body 2 intersect, that is, the multilayer body main surface A and the multilayer body lateral surface B, the multilayer body main surface A and the multilayer body end surface C, or the multilayer body lateral surface B and the multilayer body end surface C intersect.

The multilayer body 2 includes a multilayer body main body 10 including an inner layer portion 11 and outer layer portions 12 respectively provided on both sides of the inner layer portion 11 in the height direction T, and side gap portions 30 provided on both sides of the multilayer body main body 10 in the width direction W.

### Inner Layer Portion 11

The inner layer portion 11 includes a plurality of sets of ceramic layers 14 and internal electrode layers 15 alternately laminated along the height direction T.

### Ceramic Layer 14

Each ceramic layer 14 is made of a ceramic material. Although the ceramic material is not particularly limited, for example, a dielectric ceramic including BaTiO₃ as a main component is used. In addition, as the ceramic material, a material obtained by adding at least one subcomponent such as, for example, a Mn compound, a Fe compound, a Cr compound, a Co compound, or a Ni compound to these main components may be used.

The internal electrode layers 15 include a plurality of first internal electrode layers 15a and a plurality of second internal electrode layers 15b. The first internal electrode layers 15a and the second internal electrode layers 15b are alternately provided. When it is not necessary to particularly distinguish the first internal electrode layer 15a and the second internal electrode layer 15b from each other, they are collectively described as the internal electrode layer 15.

Each first internal electrode layer 15a includes a first counter portion 152a opposed to the second internal electrode layer 15b, and a first extension portion 151a extending from the first counter portion 152a toward the first multilayer body end surface C1. The first extension portion 151a includes an end portion which is exposed at the first multilayer body end surface C1 and is electrically connected to a first external electrode 3a described later. Each second internal electrode layer 15b includes a second counter portion 152b opposed to the first internal electrode layer 15a, and a second extension portion 151b extending from the second counter portion 152b toward the second multilayer body end surface C2. The second extension portion 151b includes an end portion which is electrically connected to a second external electrode 3b described later. Electric charge is accumulated in the first counter portion 152a of the first internal electrode layer 15a and the second counter portion 152b of the second internal electrode layer 15b, which defines and functions as a capacitor.

Each internal electrode layer 15 is preferably made of, for example, a metal material including Ni, Cu, Ag, Pd, Ag—Pd alloy, Au, or the like.

### Outer Layer Portion 12

Each outer layer portion 12 is preferably made of the same material as the ceramic layer 14 of the inner layer portion 11.

### Side Gap Portion 30

Each side gap portion 30 is preferably made of the same material as that of the ceramic layer 14.

### External Electrode 3

The external electrode 3 includes a first external electrode 3a provided on the first multilayer body end surface C1 and a second external electrode 3b provided on the second multilayer body end surface C2. When it is not necessary to particularly distinguish the first external electrode 3a and the second external electrode 3b from each other, they will be collectively described as the external electrode 3. Each external electrode 3 covers not only the multilayer body end surface C, but also a portion of the multilayer body main surface A and a portion of the multilayer body lateral surface B adjacent to the multilayer body end surface C.

As described above, the end portion of the first extension portion 151a of the first internal electrode layer 15a is exposed at the first multilayer body end surface C1, and is electrically connected to the first external electrode 3a. In addition, the end portion of the second extension portion 151b of the second internal electrode layer 15b is exposed at the second multilayer body end surface C2, and is electrically connected to the second external electrode 3b. Thus, a plurality of capacitor elements are electrically connected in parallel between the first external electrode 3a and the second external electrode 3b.

Each external electrode 3 may have, for example, a two-layer configuration including a base electrode layer and a plated layer. The plated layer may include one layer or two layers. In addition, an electrically conductive resin layer may be provided between the base electrode layer and the plated layer. The base electrode layer is formed by, for example, applying and firing an electrically conductive paste including an electrically conductive metal and glass. As the electrically conductive metal of the base electrode layer, for example, Cu, Ni, Ag, Pd, an Ag—Pd alloy, Au, or the like is preferably used. The plated layer is preferably made of, for example, Cu, Ni, Su, Ag, Pd, an Ag—Pd alloy, Au, or the like, or an alloy including the metal.

### Spacer 4

In the example embodiments, the spacers 4 include a first spacer 4A provided adjacent to the first multilayer body end surface C1 and a second spacer 4B provided adjacent to the second multilayer body end surface C2 on the second multilayer body main surface A2 of the multilayer ceramic capacitor 1A.

The surface on which the spacers 4 are provided is not limited to the second multilayer body main surface A2 of the multilayer ceramic capacitor 1A. For example, they may be provided on one of the multilayer body lateral surfaces B of the multilayer ceramic capacitor 1A. In this case, the multilayer body lateral surface B functions as a mounting surface.

Hereinafter, when it is not necessary to distinguish between the first spacer 4A and the second spacer 4B, they will be collectively described as the spacer 4. The first spacer 4A and the second spacer 4B are spaced apart from each other by a predetermined distance.

### Outer Surface of Spacer 4

Among the six outer surfaces of each of the first spacer 4A and the second spacer 4B, a pair of outer surfaces opposed to each other in the height direction T is defined as a spacer main surface a. The outer surface of the two spacer main surfaces a adjacent to the multilayer ceramic capacitor 1A is referred to as a first spacer main surface a1, and the outer surface adjacent to the other mounting is referred to as a second spacer main surface a2. The first spacer main surface a1 of the spacer 4 opposes the second multilayer body main surface A2 of the multilayer ceramic capacitor 1A and is connected to the external electrode 3 extending to the second multilayer body main surface A2.

Among the six outer surfaces of each of the first spacer 4A and the second spacer 4B, a pair of outer surfaces opposed to each other in the width direction W is referred to as a first spacer lateral surface b1 and a second spacer lateral surface b2. Among the pairs of outer surfaces opposed to each other in the length direction L, the surfaces of the first spacer 4A and the second spacer 4B opposed to each other are referred to as a second spacer end surface c2, and the surfaces of the first spacer 4A and the second spacer 4B each facing the outside are referred to as a first spacer end surface c1.

When it is not necessary to particularly distinguish between these pairs of surfaces, the first spacer main surface a1 and the second spacer main surface a2 are collectively referred to as a spacer main surface a, the first spacer lateral surface b1 and the second spacer lateral surface b2 are collectively referred to as a spacer lateral surface b, and the first spacer end surface c1 and the second spacer end surface c2 are collectively referred to as a spacer end surface c.

### Materials for Spacer 4

The spacer 4 can be manufactured from an arbitrary electrically conductive component, but is preferably manufactured from, for example, a component including, as a main component, an intermetallic compound including at least one high melting point metal of Cu or Ni and Sn as a low melting point metal. The spacer 4 may be made of, for example, an electrically conductive resin.

For example, the spacer 4 may be manufactured to include about 31.5% of Ni powder having a D50 (median diameter) of about 5 μm and including about 10 wt % of Cu, about 58.5 wt % of solder powder having a Cu composition including about 3 wt % of Sn and about 0.5 wt % of Ag, and about 10 wt % of the total of phenol resin, solvent, and additive.

In addition, for example, the spacer 4 may be manufactured to include about 31.5% of Ni powder having a D50 of about 5 μm including about 10 wt % of Cu, about 58.5 wt % of solder powder having a Cu composition including about 3 wt % of Sn and about 0.5 wt % of Ag, and about 10 wt % total of rosin, solvent, and additive.

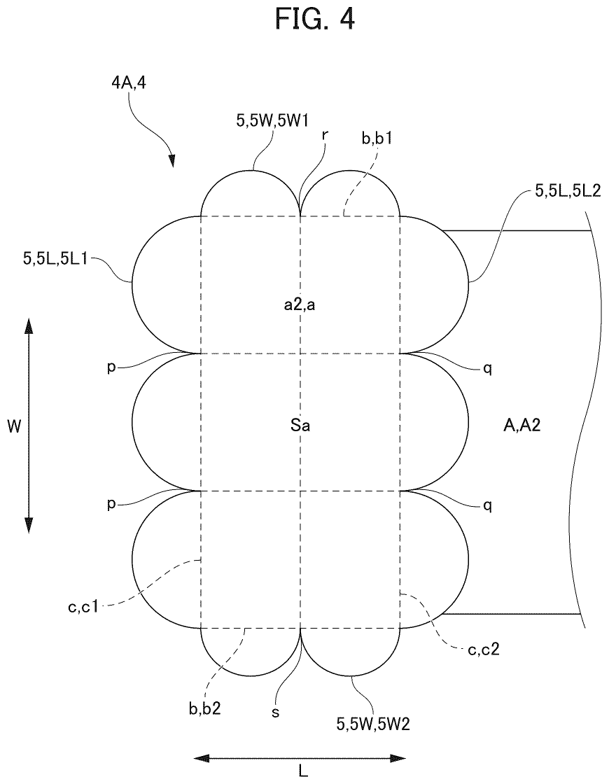

FIG. 4 is a plan view of a portion of the multilayer ceramic electronic component 1 to which the first spacer 4A is attached as viewed from the second spacer main surface a2. Although the following description will be provided using the first spacer 4A, the same applies to the second spacer 4B, and therefore, the first spacer 4A and the second spacer 4B will be collectively described as the spacer 4.

### Protruding Portion 5

The spacer 4 includes at least one protruding portion 5 protruding outward when viewed in the plan view shown in FIG. 4. The protruding portions 5 include protruding portions 5L protruding in the length direction L, and in the present example embodiment, further include protruding portions 5W protruding in the width direction W.

### Shape of Protruding Portion 5

When viewed in a plan view as shown in FIG. 4, for example, the protruding portions 5 each preferably have an arc shape or an elliptical arc shape, more preferably have a semicircular shape, and in the present example embodiment, have a semicircular shape.

### Protruding Portion 5L Protruding in Length Direction L

The protruding portions 5L protruding in the length direction L include protruding portions 5L1 protruding from the first spacer end surface c1, and in the present example embodiment, further include protruding portions 5L2 protruding from the second spacer end surface c2.

In the plan view shown in FIG. 4, points obtained by dividing the first spacer end surface c1 into n pieces in the width direction W are defined as p. When the first spacer end surface c1 is divided by a straight line passing through the point p and extending along the length direction L, one protruding portion 5L1 is included in each of the n divided regions. That is, the spacer 4 includes the n number of protruding portions 5L1 protruding in the length direction L from the first spacer end surface c1 in the plan view shown in FIG. 4. Preferably, for example, n is 2 to 6, and in the present example embodiment shown in FIG. 4, n is 3.

In the present example embodiment, the protruding portions 5L2 protruding from the second spacer end surface c2 are also included similarly. That is, points obtained by dividing the second spacer end surface c2 into n pieces in the width direction W in the plan view shown in FIG. 4 are defined as q. When the second spacer end surface c2 is divided by a straight line that passes through the point q and extends along the length direction L, one protruding portion 5L2 is included in each of the n divided regions. That is, the spacer 4 includes the n number of protruding portions 5L2 protruding in the length direction L from the second spacer end surface c2 in the plan view shown in FIG. 4. Preferably, for example, n is 2 to 6, and in the present example embodiment shown in FIG. 4, n is 3.

### Protruding Portion 5W Protruding in Width Direction W

The protruding portions 5W protruding in the width direction W include protruding portions 5W1 protruding from the first spacer lateral surface b1 and protruding portions 5W2 protruding from the second spacer lateral surface b2.

In the plan view shown in FIG. 4, a point obtained by dividing the first spacer lateral surface b1 by m in the length direction L is defined as r. When the first spacer lateral surface b1 is divided by a straight line passing through the point r and extending along the width direction W, one protruding portion 5W1 is included in each of the m divided regions. That is, the spacer 4 includes the m number of protruding portions 5W1 protruding from the first spacer lateral surface b1 in the width direction W in the plan view shown in FIG. 4. Preferably, for example, m is 1 or 2, and in the present example embodiment shown in FIG. 4, m is 2. In this specification, m division also includes the case where m=1.

In the present example embodiment, the protruding portion 5W2 protruding from the second spacer lateral surface b2 is also included similarly. That is, a point obtained by dividing the second spacer lateral surface b2 by m in the length direction L in the plan view shown in FIG. 4 is defined as s. When the second spacer lateral surface b2 is divided by a straight line passing through the point s and extending along the width direction W, one protruding portion 5W2 is included in each of the m divided regions. That is, the spacer 4 includes the m number of protruding portions 5W1 protruding in the width direction W from the second spacer lateral surface b2 in the plan view shown in FIG. 4. Preferably, for example, m is 1 or 2, and in the present example embodiment shown in FIG. 4, m is 2.

### Equal Portions

The above-described n divisions and m divisions are preferably, but not limited to, equal or substantially equal divisions, and are equal or substantially equal divisions in the example embodiment.

### n Equal Portions

When the spacer end surface c is divided into n equal or substantially equal portions in the width direction W in the plan view shown in FIG. 4, it indicates that a straight line passing through the spacer end surface c is divided into n equal or substantially equal portions between the intersection point of a straight line passing through the first spacer lateral surface b1 and the straight line passing through the spacer end surface c, and the intersection point of a straight line passing through the second spacer lateral surface b2 and the straight line passing through the spacer end surface c.

### m Equal Portions

When the spacer lateral surface c is divided into m equal or substantially equal portions in the length direction L in the plan view shown in FIG. 4, it indicates that a straight line passing through the spacer lateral surface b is divided into equal or substantially equal portions between the intersection point of a straight line passing through the first spacer end surface c1 and the straight line passing through the spacer lateral surface b, and the intersection point of the straight line passing through the second spacer end surface c2 and the straight line passing through the spacer lateral surface b.

When the straight line passing through the spacer end surface c and the straight line passing through the spacer lateral surface b are unclear due to the provision of the protruding portion 5, the following processing is performed.

A line extending in the width direction W passing through the most recessed position between the protruding portion 5L and the protruding portion 5L is defined as a straight line passing through the spacer end surface c, and in a case where a plurality of recessed positions between the protruding portion 5L and the protruding portion 5L exist and the plurality of positions are different from each other, a line extending in the width direction W passing through the most recessed position among the most recessed positions is defined as a straight line passing through the spacer end surface c.

A line extending in the length direction L passing through the recessed portion between the protruding portion 5W and the protruding portion 5W is defined as a straight line passing through the spacer lateral surface b, and in a case where a plurality of recessed positions between the protruding portion 5W and the protruding portion 5W exist and the plurality of positions are different from each other, a line extending in the length direction L passing through the most recessed position among the most recessed positions is defined as a straight line passing through the spacer lateral surface b. In a case where there is one protruding portion 5W, a straight line passing through a recessed portion between the protruding portion 5W and the protruding portion 5L is defined as a straight line passing through the spacer lateral surface b.

In addition, in the spacer 4, when the area of the second spacer main surface a2 shown in FIG. 4 is defined as Sa, the average area of the first spacer lateral surface b1 and the second spacer lateral surface b2 is defined as Sb (shown in FIG. 1), the average area of the first spacer end surface c1 and the second spacer end surface c2 is defined as Sc (shown in FIGS. 1 and 3), Sa/(Sb+Sc) when the protruding portion 5 is not provided is defined as S0, and Sa/(Sb+Sc) when the protruding portion 5 is provided is defined as S1, S1/S0 is, for example, preferably about 1.05 or more, and more preferably, S1/S0 is about 1.12 or more.

The areas of Sa, Sb, and Sc can be measured as follows.

When the multilayer ceramic electronic component 1 is mounted on the board with solder, the multilayer ceramic electronic component 1 is removed from the board using, for example, a bond tester (DAGE (registered trademark), DAGE-5000). Thereafter, images of the respective surfaces are obtained by, for example, laser scanning with a laser microscope (Keyence (registered trademark), VK-X1000, magnification 20 times), and the areas of Sa, Sb, and Sc are measured with, for example, analysis software (Keyence (registered trademark), multifile analysis application). The same applies to the multilayer ceramic electronic component 1 that is not mounted on the board.

### Manufacturing Method of Multilayer Ceramic Electronic Component 1

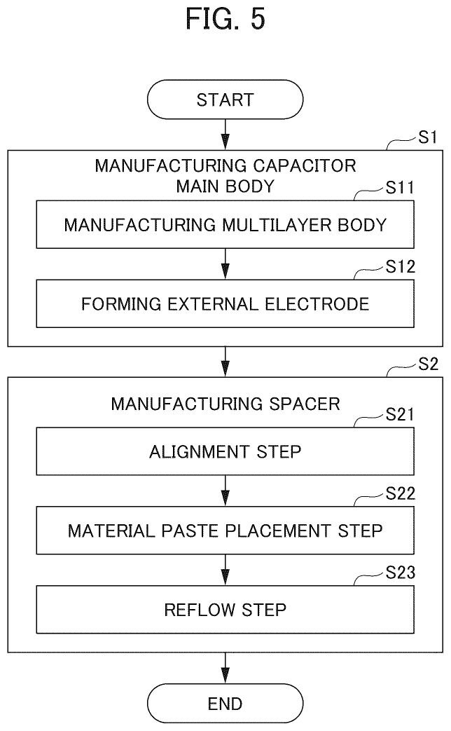

FIG. 5 is a flowchart showing an example of a method of manufacturing the multilayer ceramic electronic component 1. The method for manufacturing the multilayer ceramic electronic component 1 includes a multilayer ceramic capacitor manufacturing step S1 and a spacer manufacturing step S2.

### Multilayer Ceramic Capacitor Manufacturing Step S1

The multilayer ceramic capacitor manufacturing step S1 includes a multilayer body manufacturing step S11 and an external electrode forming step S12.

### Multilayer Body Manufacturing Step S11

A ceramic slurry including a ceramic powder, a binder, and a solvent is molded into a sheet shape on a carrier film using, for example, a die coater, a gravure coater, a microgravure coater, or the like to produce a ceramic green sheet defining and functioning as the ceramic layer 14. Next, an electrically conductive paste is printed on the ceramic green sheet for lamination in a band shape by, for example, screen printing, inkjet printing, gravure printing, or the like, and an electrically conductive pattern defining and functioning as the internal electrode layer 15 is printed on the surface of the ceramic green sheet for lamination, thus producing a printed material sheet. At this time, the electrically conductive paste may be formed in a desired pattern to form the side gap portion 30.

Subsequently, the plurality of material sheets are laminated so that the electrically conductive patterns face the same direction and the electrically conductive patterns are shifted by about a half pitch in the width direction W between the adjacent material sheets. In addition, the ceramic green sheets for manufacturing the outer layer portion defining and functioning as the outer layer portions 12 are laminated on both sides of the plurality of laminated material sheets.

The plurality of laminated material sheets and the ceramic green sheets for manufacturing the outer layer portion are thermocompression-bonded to form a mother block. Next, the mother block is cut to manufacture the multilayer body main body 10, and the side gap portion 30 is formed in the multilayer body main body 10 to manufacture the multilayer body 2.

### External Electrode Forming Step S12

Subsequently, the external electrode 3 is formed by applying and firing an electrically conductive paste including an electrically conductive metal and glass to the multilayer body end surface C of the multilayer body 2. The external electrode 3 is formed so as to cover not only the multilayer body end surface C on both sides of the multilayer body 2, but also a portion of the multilayer body main surface A and a portion of the multilayer body lateral surface B. Through the above steps, the multilayer ceramic capacitor 1A is manufactured.

### Spacer Manufacturing Step S2

The spacer manufacturing step S2 includes an alignment step S21, a material paste providing step S22, and a reflow step S23.

### Alignment Step S21

The multilayer ceramic capacitors 1A are arranged on the holding board using suction nozzles so as to be aligned at predetermined positions. The holding board is preferably capable of holding the multilayer ceramic capacitors 1A and has heat resistance. The holding board is preferably, for example, a board in which a polyimide double-sided tape is attached to an alumina plate on which the metal material paste is not bonded under reflow conditions. The metal material paste may include, for example, a resin, and the resin may be a phenolic resin.

### Material Paste Providing Step S22

A metal material paste defining and functioning as the spacers 4 is formed in a desired pattern on the multilayer ceramic capacitors 1A aligned on the holding board by, for example, screen printing using a squeegee. At this time, for example, a masking jig is prepared, and the masking jig is provided on the multilayer ceramic capacitors 1A aligned on the holding board. The masking jig includes a plurality of through holes penetrating from one main surface to the other main surface. Each of the through holes has a shape according to the purpose, and the shape of each of the spacers 4 is determined by the difference in the shape.

### Reflow Step S2

Subsequently, reflow is performed in a state where the metal material paste is formed in a predetermined pattern on the multilayer ceramic capacitors 1A. As a result, the metal in the metal material paste generates an intermetallic compound, and the metal material paste is cured to complete the multilayer ceramic electronic components 1 in which the spacers 4 each having a desired shape are attached to the multilayer ceramic capacitor 1A.

### Modified Example

In each of the spacers 4 in the multilayer ceramic electronic component 1 of the example embodiment described above, a total of three protruding portions 5L1 are provided one by one in each region obtained by dividing the first spacer end surface c1 into three equal or substantially equal portions in the width direction W, a total of three protruding portions 5L1 are provided one by one in each region obtained by dividing the second spacer end surface c2 into three equal or substantially equal portions in the width direction W, a total of two protruding portions 5W1 are provided one by one in each region obtained by dividing the first spacer lateral surface b1 into two equal or substantially equal portions in the length direction L, and a total of two protruding portions 5W2 are provided one by one in each region obtained by dividing the second spacer lateral surface b2 into two equal or substantially equal portions in the length direction L.

However, the present invention is not limited thereto.

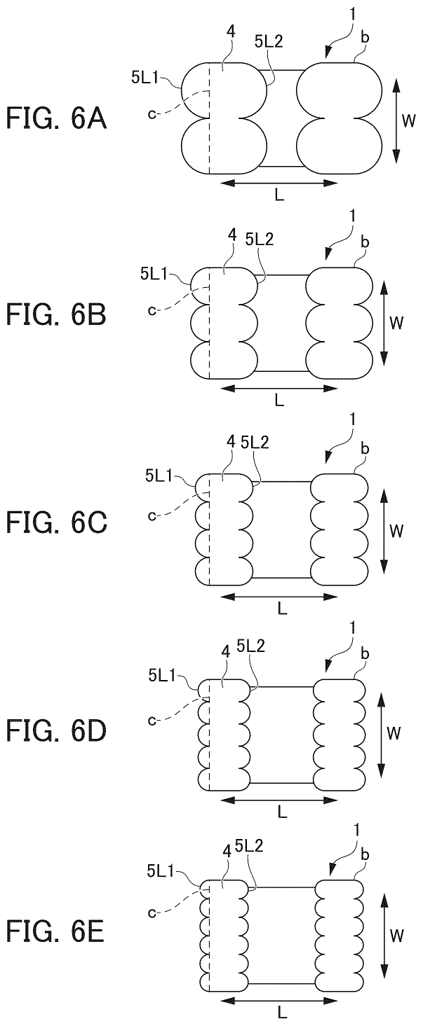

FIGS. 6A to 6E, FIG. 7, FIG. 8, and FIG. 9 are views, each showing modified examples of the spacer 4.

For example, the protruding portion 5W may not be provided on the spacer lateral surface b. The number of protruding portions 5L provided on the spacer end surface c may not necessarily be three. FIGS. 6A to 6E are views showing a configuration in which the protruding portion 5W is not provided on the spacer lateral surface b. FIG. 6A shows a configuration in which two spacer end surfaces c are equally or substantially equally divided into two in the width direction W, and a total of two protruding portions 5L are provided in each region. FIG. 6B shows a configuration in which two spacer end surfaces c are equally or substantially equally divided into three in the width direction W, and a total of three protruding portions 5L are provided in each region. FIG. 6C shows a configuration in which two spacer end surfaces c are equally or substantially equally divided into four in the width direction W, and a total of four protruding portions 5L are provided in each region. FIG. 6D shows a configuration in which two spacer end surfaces c are equally or substantially equally divided into five in the width direction W, and a total of five protruding portions 5L are provided in each region. FIG. 6E shows a configuration in which two spacer end surfaces c are equally or substantially equally divided into six portions in the width direction W, and a total of six protruding portions 5L are provided in each region.

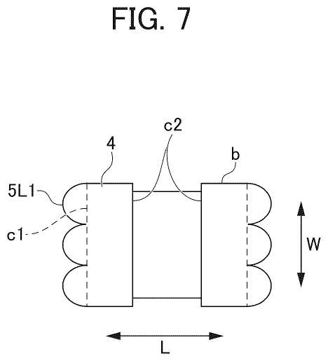

In addition, for example, the protruding portion 5L may not necessarily be provided on the second spacer end surface c2. In FIG. 7, the protruding portions 5L are provided on the first spacer end surface c1, but no protruding portion 5 is provided on the spacer lateral surface b or the second spacer end surface c2.

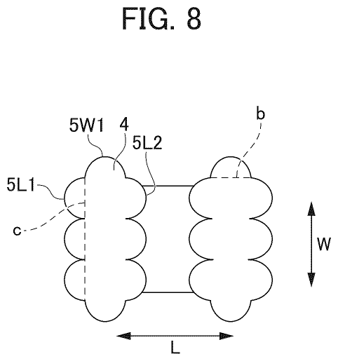

In addition, for example, one protruding portion 5W may be provided on the spacer lateral surface b. FIG. 8 shows a configuration in which each of the two spacer end surfaces c is equally or substantially equally divided into three portions in the width direction W, a total of three protruding portions 5L are provided in each region, and one protruding portion 5W is respectively provided on the two spacer lateral surfaces b.

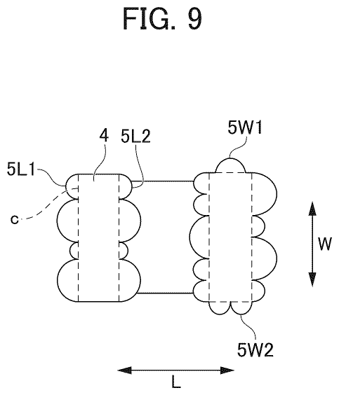

The protruding portions 5L provided on the spacer end surface c may not necessarily be provided at equal or substantially equal intervals. The first spacer 4A and the second spacer 4B may have different numbers of protruding portions 5. FIG. 9 shows a configuration in which the protruding portions 5L (5L1, 5L2) protruding in the length direction L are provided at uneven intervals on each of the two spacer end surfaces c, and none, one, or two of the protruding portions 5W (5W1, 5W2) protruding in the width direction W are provided on the two spacer lateral surfaces b.

### Advantageous Effects

When a voltage is applied to the multilayer ceramic capacitor 1A, “acoustic noise” unique to the multilayer ceramic capacitor 1A occurs. In order to reduce or prevent the occurrence of the “acoustic noise”, the multilayer ceramic electronic component 1 is configured by providing the spacers 4 on the lateral surface of the multilayer ceramic capacitor 1A to be mounted on the board. However, when the multilayer ceramic electronic component 1 is mounted on a board using solder, there is a possibility that the solder spreads beyond the spacers 4 and extends to the external electrodes 3 of the multilayer ceramic capacitor 1A. In such a case, it is not possible to sufficiently achieve the advantageous effects of the reduction or prevention of acoustic noise.

However, the spacers 4 included in the multilayer ceramic electronic component 1 each include the protruding portions 5 protruding outward when viewed in the plan view shown in FIG. 4. The protruding portions 5 include the protruding portions 5L protruding in the length direction L, and further include the protruding portions 5W protruding in the width direction W. The protruding portions 5L protruding in the length direction L include the protruding portions 5L1 protruding from the first spacer end surface c1, and further include the protruding portions 5L2 protruding from the second spacer end surface c2.

As described above, in the present example embodiment, the protruding portions 5L1 are included in the first spacer end surface c1 where the solder easily spreads when the multilayer ceramic electronic component 1 is mounted on the board. Therefore, when the solder spreads on the first spacer end surface c1, the solder can be trapped between the protruding portions 5L1. This makes it possible to reduce or prevent the solder from spreading to the external electrodes 3 of the multilayer ceramic capacitor 1A at the first spacer end surface c1. Therefore, it is possible to sufficiently obtain the reduction or prevention of acoustic noise.

In addition, the multilayer ceramic electronic component 1 includes the protruding portions 5W protruding in the width direction W. When the solder spreads on the spacer lateral surface b, it is possible to trap the solder between the protruding portions 5W. Therefore, it is possible to reduce or prevent the spreading of the solder on the spacer lateral surface b to the external electrodes 3 of the multilayer ceramic capacitor 1A. Therefore, it is possible to obtain further reduction of acoustic noise.

In addition, the multilayer ceramic electronic component 1 includes the protruding portions 5L2 protruding from the second spacer end surface c2. When the solder spreads on the second spacer end surface c2, it is possible to trap the solder between the protruding portions 5L2. Therefore, it is possible to reduce or prevent the spreading of the solder on the second spacer end surface c2 to the external electrodes 3 of the multilayer ceramic capacitor 1A. Therefore, it is possible to obtain further reduction of acoustic noise.

### Evaluation of Advantageous Effects of Multilayer Ceramic Electronic Component 1

Next, the evaluation of the advantageous effects of the acoustic noise reduction of the multilayer ceramic electronic component 1 will be described. First, the following multilayer ceramic electronic components 1 were prepared.

The dimensions of each of the multilayer ceramic capacitors 1A included in the multilayer ceramic electronic components 1 are as follows.
Length direction L: about 1.70±0.10 mm
Width direction W: about 0.90±0.10 mm
Height direction: about 0.90±0.10 mm
Main component of internal electrode: Ni
Main component of ceramic layer: BaTiO₃
External electrode configuration: base electrode layer of Cu including glass+Ni/Sn plated layer

The following two types of spacers 4 were provided on the multilayer ceramic capacitors 1A.

### (1) Spacers 4 Including Protruding Portions 5L Provided on Spacer End Surface c

In these spacers 4 in which the protruding portions 5L are provided on the spacer end surface c, no protruding portions 5W were provided on the spacer lateral surface b. In the spacers 4, one protruding portion 5L was provided in each of the n pieces of divided regions of the two spacer end surfaces c. As the multilayer ceramic electronic component 1 of the present example embodiment, five multilayer ceramic electronic components each having n of 2 to 8 were prepared, and five multilayer ceramic electronic components each having n of 0 were prepared as Comparative Examples.

### (2) Spacers 4 Including Protruding Portions 5W Provided on Spacer Lateral Surface b

In these spacers 4 in which the protruding portions 5W are provided on the spacer lateral surface b, no protruding portions 5L were provided on the spacer end surface c. In the spacers 4, one protruding portion 5W was provided in each of the m pieces of divided regions of the two spacer lateral surfaces b. As the multilayer ceramic electronic component 1 of the present example embodiment, five multilayer ceramic electronic components each having m of 1 to 4 were prepared, and five multilayer ceramic electronic components each having m of 0 were prepared as Comparative Examples.

The dimensions of each of the spacers 4 including the protruding portion 5 were as follows.
Length direction L: about 0.45 mm±0.05 mm
Width direction W: about 0.85 mm±0.05 mm
Height direction: about 0.15 mm±0.05 mm

The dimensions of each of the spacers 4 were dimensions including the protruding portions 5 when viewed in the plan view shown in FIG. 4.

The protruding portions 5 were not provided so as to protrude from each of the spacers 4 having the above-described dimensions.

The spacers 4 used each included about 31.5% of Cu-10 wt % Ni powder having a D50 of about 5 μm, about 58.5 wt % of solder powder having a Cu composition including about 3 wt % Sn and about 0.5 wt % Ag, and about 10 wt % total of phenol resin, solvent, and additive.

### Sound Pressure Level Measurement

Each multilayer ceramic electronic component 1 was mounted on a board, placed in an anechoic box, and a sound collecting microphone was placed on the multilayer ceramic electronic component 1 so as to oppose the board.

Next, an alternating current having a frequency of about 3 kHz and a voltage of about 1 Vpp was applied to the multilayer ceramic electronic component 1, and the sound level of the multilayer ceramic electronic component 1 was measured by a sound collecting microphone. At this time, the sound of the multilayer ceramic electronic component 1 was collected by a sound collection microphone at a position about 3 mm above the board, and the output of the sound collection microphone was inputted to an FFT (Fast Fourier Transform) analyzer via a sound collector, where the sound pressure level was analyzed.

For the sound pressure level obtained as described above, samples each including the protruding portion 5 and the area ratio were measured.

### Evaluation Results

### (1) Spacer 4 Including Protruding Portion 5L Provided on Spacer End Surface c

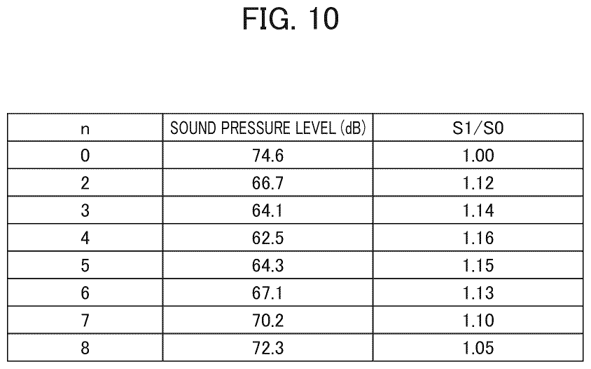

FIG. 10 is a table showing average sound pressure levels obtained by preparing five multilayer ceramic electronic components 1 according to an example embodiment of the present invention in which the number n of the protruding portions 5L is 2 to 8 and five multilayer ceramic electronic components according to a Comparative Example in which the number n of the protruding portions 5L is 0, and measuring sound pressure levels by the above-described evaluation method, as the spacer 4 in which the protruding portions 5L were provided on the spacer end surface c.

FIG. 10 also shows the value of S1/S0 when the area of the second spacer main surface a2 is defined as Sa, the average area of the first spacer lateral surface b1 and the second spacer lateral surface b2 is defined as Sb, the average area of the first spacer end surface c1 and the second spacer end surface c2 is defined as Sc, Sa/(Sb+Sc) when the protruding portion 5 is not provided is defined as S0, and Sa/(Sb+Sc) when the protruding portion 5 is provided is defined as S1.

As shown in FIG. 10, in the Comparative Example in which n=0, that is, the protruding portion 5 is not provided, the sound pressure level was about 74.6 dB. However, in the cases where the protruding portion 5L is provided as in example embodiments of the present invention, all of the sound pressure levels were lower than that in the Comparative Example, and it was evaluated that such cases achieved the advantageous effects of reducing the acoustic noise.

In addition, it was evaluated that in the case of n=2 to 6, the sound pressure levels were 70 dB or less, and such cases exhibited a further improved advantageous effect of reducing acoustic noise.

As shown in FIG. 10, in the Comparative Example in which S1/S0 was about 1, the sound pressure level was about 74.6 dB. However, it was evaluated that when S1/S0 was about 1.05 or more, all of the sound pressure levels were lower than that of the Comparative Example, and such cases achieved the advantageous effects of reducing acoustic noise. In addition, it was evaluated that when S1/S0 was about 1.12 or more, the sound pressure level becomes about 70 dB or less, and such cases achieved further enhanced advantageous effects of reducing acoustic noise.

### (2) Spacer 4 Including Protruding Portion 5W Provided on Spacer Lateral Surface b

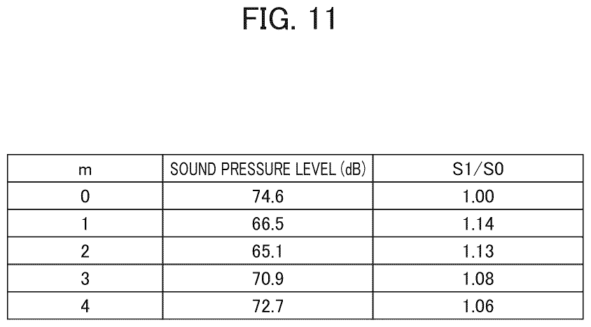

FIG. 11 is a table showing average sound pressure levels obtained by preparing five multilayer ceramic electronic components 1 according to an example embodiment of the present invention in which the number m of the protruding portions 5M is 1 to 4 and five multilayer ceramic electronic components according to a Comparative Example in which the number m of the protruding portions 5W is 0, and measuring sound pressure levels by the above-described evaluation method, as the spacer 4 in which the protruding portions 5M were provided on the spacer lateral surface b.

FIG. 11 also shows the value of S1/S0 when the area of the second spacer main surface a2 is defined as, the average area of the first spacer lateral surface b1 and the second spacer lateral surface b2 is defined as Sb, the average area of the first spacer end surface c1 and the second spacer end surface c2 is defined as Sc, Sa/(Sb+Sc) when the protruding portion 5 is not provided is defined as S0, and Sa/(Sb+Sc) when the protruding portion 5 is provided is defined as S1.

As shown in FIG. 11, in the Comparative Example in which m=0, that is, the protruding portion 5 is not provided, the sound pressure level was about 74.6 dB. However, in the cases where the protruding portion 5W is provided as in the present invention, all of the sound pressure levels were lower than that in the Comparative Example, and it was evaluated that such cases achieved the advantageous effects of reducing the acoustic noise. In addition, it was evaluated that in the case of m=1 or 2, the sound pressure level was about 70 dB or less, and such a case achieved further improved advantageous effects of reducing acoustic noise.

As shown in FIG. 11, in the Comparative Example in which S1/S0 was about 1.00, the sound pressure level was about 74.6 dB. However, it was evaluated that when S1/S0 was about 1.06 or more, all of the sound pressure levels were lower than that of the Comparative Example, and such cases achieved the advantageous effects of reducing acoustic noise.

In addition, it was evaluated that when S1/S0 was about 1.13 or more, the sound pressure level becomes about 70 dB or less, and such cases achieved a further improved advantageous effect of reducing acoustic noise.

In addition, when the protruding portion 5L was provided on the spacer end surface c, the protruding portion 5W was not provided on the spacer lateral surface b. In addition, when the protruding portion 5W was provided on the spacer lateral surface b, the protruding portion 5L was not provided on the spacer end surface c. However, in a case where the protruding portion 5 is further provided on a surface other than the surface on which the protruding portion 5 is provided, since the amount of solder trapped is increased, it is considered that the advantageous effects of reducing acoustic noise is equal or higher.

In addition, as the size of the multilayer ceramic capacitor 1A increases, the size or the number of the protruding portions 5 provided in the spacer 4 can be increased. However, as the number of the protruding portions 5 increases, the spacer main surface a becomes closer to a rectangular or substantially rectangular shape in a plan view in the direction shown in FIG. 4. Further, as the number of the protruding portions 5 increases, the individual protruding portions become smaller, so that when the number of the protruding portions 5 becomes equal to or more than a predetermined number, S1/S0 starts to approach 1, and the amount of solder trapped on the surface of the spacer 4 decreases. Therefore, the advantageous effects of reducing or preventing the spreading of the solder on the second spacer end surface c2 to the external electrode 3 of the multilayer ceramic capacitor 1A are reduced, and the sound pressure level increases as shown in FIGS. 10 and 11.

Although example embodiments of the present invention have been described above, the present invention is not limited to the example embodiments, and can be provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer ceramic capacitor including:
a multilayer body including two multilayer body main surfaces opposed to each other in a first direction, two multilayer body lateral surfaces opposed to each other in a second direction intersecting the first direction, and two multilayer body end surfaces opposed to each other in a third direction intersecting the first direction and the second direction; and
external electrodes each extending from a corresponding one of the two multilayer body end surfaces to a corresponding one of the two multilayer body main surfaces; and
two spacers on one of the two multilayer body main surfaces of the multilayer ceramic capacitor, one of the two spacers being adjacent to one of the two multilayer body end surfaces, and an other of the two spacers being adjacent to an other of the two multilayer body end surfaces; wherein
each of the two spacers includes two spacer main surfaces opposed to each other in the first direction, two spacer lateral surfaces opposed to each other in the second direction, and two spacer end surfaces opposed to each other in the third direction; and
when one of the two spacers is divided into n number of divided regions in the second direction in a plan view viewed from one of the two spacer main surfaces, each of the n number of divided regions includes one protruding portion protruding in the third direction.

2. The multilayer ceramic electronic component according to claim 1, wherein, when one of the two spacers is divided into n number of equal or substantially equal portions in the second direction in a plan view viewed from one of the two spacer main surfaces, each of the n number of equal or substantially equal portions includes one protruding portion protruding in the third direction.

3. The multilayer ceramic electronic component according to claim 1, wherein the n is in a range of 2 to 6.

4. The multilayer ceramic electronic component according to claim 1, wherein the protruding portion is provided on both of the two spacer end surfaces of one of the two spacers, and the two spacer end surfaces are opposed to each other in the third direction.

5. The multilayer ceramic electronic component according to claim 1, wherein, when one of the two spacers is divided into m number of divided regions in the third direction in a plan view viewed from one of the two spacer main surfaces, each of the m number of divided regions includes one protruding portion protruding in the second direction.

6. The multilayer ceramic electronic component according to claim 5, wherein, when one of the two spacers is divided into m number of equal or substantially equal portions in the third direction in a plan view viewed from one of the two spacer main surfaces, each of the m number of equal or substantially equal portions includes one protruding portion protruding in the second direction.

7. The multilayer ceramic electronic component according to claim 5, wherein the m is 1 or 2.

8. The multilayer ceramic electronic component according to claim 5, wherein the protruding portion is provided on both of the two spacer lateral surfaces of one of the two spacers, and the two spacer lateral surfaces are opposed to each other in the second direction.

9. The multilayer ceramic electronic component according to claim 1, wherein the protruding portion has a semicircular shape.

10. The multilayer ceramic electronic component according to claim 1, wherein, when an area of the one of the two spacer main surfaces is defined as Sa, an average area of the two spacer lateral surfaces when viewed from the second direction is defined as Sb, an average area of the two spacer end surfaces when viewed from the third direction is defined as Sc, Sa/(Sb+Sc) in a case where the protruding portion is not provided is defined as S0, and Sa/(Sb+Sc) in a case where the protruding portion is provided is defined as S1, S1/S0 is about 1.05 or more.

11. The multilayer ceramic electronic component according to claim 10, wherein S1/S0 is about 1.12 or more.

12. The multilayer ceramic electronic component according to claim 2, wherein the n is in a range of 2 to 6.

13. The multilayer ceramic electronic component according to claim 6, wherein the m is 1 or 2.

14. The multilayer ceramic electronic component according to claim 2, wherein, when an area of the one of the two spacer main surfaces is defined as Sa, an average area of the two spacer lateral surfaces when viewed from the second direction is defined as Sb, an average area of the two spacer end surfaces when viewed from the third direction is defined as Sc, Sa/(Sb+Sc) in a case where the protruding portion is not provided is defined as S0, and Sa/(Sb+Sc) in a case where the protruding portion is provided is defined as S1, S1/S0 is about 1.05 or more.

15. The multilayer ceramic electronic component according to claim 5, wherein, when an area of the one of the two spacer main surfaces is defined as Sa, an average area of the two spacer lateral surfaces when viewed from the second direction is defined as Sb, an average area of the two spacer end surfaces when viewed from the third direction is defined as Sc, Sa/(Sb+Sc) in a case where the protruding portion is not provided is defined as S0, and Sa/(Sb+Sc) in a case where the protruding portion is provided is defined as S1, S1/S0 is about 1.05 or more.

16. The multilayer ceramic electronic component according to claim 2, wherein, when one of the two spacers is divided into m number of divided regions in the third direction in a plan view viewed from one of the two spacer main surfaces, each of the m number of divided regions includes one protruding portion protruding in the second direction.

17. The multilayer ceramic electronic component according to claim 16, wherein, when one of the two spacers is divided into m number of equal or substantially equal portions in the third direction in a plan view viewed from one of the two spacer main surfaces, each of the m number of equal or substantially equal portions includes one protruding portion protruding in the second direction.
